(19) United States
(12) Patent Application Publication
(10) Pub. No.: US 2008/0305222 A1
(43) Pub. Date: Dec. 11, 2008

(54) Freezing and thawing apparatus and thawing method of frozen stuff

(75) Inventor: Shintaro Takenaka, Fukuyama-shi (JP)

Correspondence Address: MERCHANT & GOULD PC, P.O. BOX 2903, MINNEAPOLIS, MN, 55402-0903, US

(73) Assignee: SHINYO Industries, Co., Ltd., Fukuyama-shi (JP)

(21) Appl. No.: 12/156,978

(22) Filed: Jun. 6, 2008

(30) Foreign Application Priority Data
Jun. 8, 2007 (JP) 2007-177792

(51) Int. Cl. A23L 1/025; F25C 5/08; F25D 25/04; F25C 5/02

(52) U.S. Cl. 426/238; 62/349; 62/380; 62/71

(57) ABSTRACT

A freezing and thawing apparatus includes a freezing and thawing treatment tank for filling freezing and thawing treated water, a plurality of ultrasonic vibrators for oscillating ultrasound different in frequency in the freezing and thawing treatment tank, a treated water cooler for cooling the freezing and thawing treated water, and an ultrasonic vibrator controller for controlling the ultrasonic vibrators.

### BACKGROUND OF THE INVENTION

1. Field of the Invention

The present invention relates to a freezing and thawing apparatus and a thawing method of a frozen stuff.

2. Description of the Related Art

In thawing foods such as all kinds of frozen raw fresh fish and meats other than a food eaten through instantaneous high-temperature-exothermic cooking by a microwave or boiling water immersion of a retort-packed cooked food, there does not exist temperature-difference thawing by flowing tap water or temperature-difference natural thawing by moving the foods to a cooler and warmer from a freezer; therefore, it takes a long time to thaw the foods. Accordingly, there occur problems of freshness and taste.

Consequently, it is obliged to increase a thawing temperature in order to shorten a thawing time: if the thawing temperature is increased, there is a fear of a freshness degradation and various-fungi propagations; on the other hand, if the thawing temperature is decreased, there occur a moisture-vaporization diffusion and a quality degradation. Moreover, even if a magnetic wave and ultrasound are oscillated in the air, various oscillation waves in the air do not physically shorten the thawing time at all.

Furthermore, according to a recent thawing technology, thawing gradually proceeds from the outside to core of a food with taking a long time due to a temperature difference between a temperature of the food itself and an ambient temperature, that is, a temperature in an ambient thawing storage. Thus the outside of a frozen stuff is inevitably exposed to the air for a long time until its core is completely thawed; therefore, the moisture-vaporization diffusion and the freshness degradation proceed.

Then also when a food is frozen, it is packed in a freezer as it is and is frozen to its core at a freezing temperature with taking a long time in some case, with its shape being kept as it is; there is a problem that during that time the moisture of the food is vaporized and dispersed due to dry air on its outside, and that its taste is degraded.

Under such current circumstances, in a food store an amount of scheduled selling foods in the next day is started to be thawed from the previous day: if the amount of the thawed stuffs lacks, thawing by a microwave and the like is unavoidably performed; when the amount of the thawed stuffs becomes excessive, because there exist many foods that cannot be refrozen in a long time, in that case there is no method other than discarding the excessive foods. With respect to instantaneous refreezing, because there exists no facility therefor in common home, a store, and the like, there is no method other than inserting an excessive food in a freezer and freezing it with taking a few hours; however, in this case there exists no value at all as a food.

From these circumstances, there exists only a thawing method such as acquiescing a freshness degradation in a thawing apparatus, there also exists no ice temperature instantaneous thawing apparatus for instantaneously reproducing freshness at a frozen time, and a frozen stuff cannot be refrozen without its quality being degraded; therefore, it is requested to develop a better thawing technology and a rapid instantaneous thawing apparatus for an excessive frozen stuff.

### SUMMARY OF THE INVENTION

A problem of the present invention is to provide a freezing and thawing apparatus, which can perform thawing a food in a short time and perform rapid instantaneous freezing of the food with maintain food freshness; and a thawing method of a frozen stuff.

The present invention provides a freezing and thawing apparatus having a freezing and thawing treatment tank for filling freezing and thawing treated water, a plurality of ultrasonic vibrators for oscillating ultrasound different in frequency in the freezing and thawing treatment tank, and a treated water cooler for cooling the freezing and thawing treated water, the freezing and thawing apparatus further comprising an ultrasonic vibrator controller for controlling the ultrasonic vibrators.

The freezing and thawing treated water is preferably ethanol added water.

An ultrasonic vibrator is preferably attached to a tank bottom of the freezing and thawing treatment tank.

The freezing and thawing apparatus preferably further comprises a freezing and thawing treatment tank lid and at least one of the ultrasonic vibrators are attached to an underwater pressing lid of the freezing and thawing treatment tank lid.

The ultrasonic vibrator controller is preferably ultrasound oscillating electric circuit.

The freezing and thawing apparatus may further comprise an underwater wave diffusion net in the freezing and thawing treatment tank.

The freezing and thawing apparatus may further comprise a wire mesh chain conveyor.

The freezing and thawing apparatus may further comprise an underwater-rotation mesh basket in the freezing and thawing treatment tank.

The freezing and thawing apparatus may further comprise an underwater ultraviolet germicidal lamp.

The freezing and thawing apparatus may further comprise an existing power using generator, which uses power derived from a rotation of a cooler drive motor of the treated water cooler and operates.

The freezing and thawing apparatus may further comprise an in-tank treated water circulation pump.

A decomposing enzyme may be added to the freezing and thawing treated water.

A food protease enzyme may be added to the freezing and thawing treated water.

A glucoamylase enzyme may be added to the freezing and thawing treated water.

A thawing method of a frozen stuff in the freezing and thawing apparatus includes a throw-in process of throwing the frozen stuff in the freezing and thawing treatment tank where the freezing and thawing treated water is filled, and an oscillation process of oscillating ultrasound different in frequency from the ultrasonic vibrators in the freezing and thawing treatment tank; and the method further comprises a control process of controlling the ultrasonic vibrators.

The oscillation process is preferably a process of oscillating the ultrasound from the ultrasonic vibrator attached to the tank bottom of the freezing and thawing treatment tank.

The oscillation process is preferably a process of oscillating ultrasound from at least one of the ultrasonic vibrators attached to the underwater pressing lid of the freezing and thawing treatment tank lid comprised by the freezing and thawing apparatus.

The thawing method of the frozen stuff may further comprise a process of making a thrown-in frozen stuff a set vacuum package.

The thawing method of the frozen stuff may further comprise a process of making a thrown-in frozen stuff a thin-thickness container with a transparent lid.

In the thawing method of the frozen stuff, it is preferable that the food is frozen nigiri (hand-rolled) sushi including sushi shari (rice) and sushi neta (material), and that the oscillation process is a process of the ultrasonic vibrators oscillating ultrasound different in frequency toward the sushi rice and the sushi neta.

In accordance with the freezing and thawing apparatus of the present invention, it becomes possible to perform freezing and thawing a food in a short time and to maintain its freshness. Accordingly, the food may be frozen and thawed in a short time; therefore, it is not necessary to perform thawing the food from the previous day in a food store as in a conventional method, it is sufficient to start thawing the food after receiving a client's menu order; furthermore, even when an excessive thawed stuff occurs, it may be rapidly and instantly frozen, and thus it is possible to avoid a thawed remaining loss.

Then according to the thawing method of a frozen stuff in the present invention, it is possible to simultaneously thaw the outside and core of the frozen stuff and to prevent its freshness from being degraded.

### BRIEF DESCRIPTION OF THE DRAWINGS

FIG. 1 is a whole section view and partial front view of a freezing and thawing apparatus of the present invention comprising ultrasonic vibrators.

FIG. 2 is a whole section view and partial front view of a freezing and thawing apparatus of the present invention comprising ultrasonic vibrators, and not comprising a treated water cooler, wherein a thawing treatment is performed at an ice temperature of a crushed ice thrown-in water.

FIG. 3 is a plan view of a freezing and thawing treatment tank where ultrasonic vibrators penetrate a tank bottom and underwater pressing lid of the freezing and thawing treatment tank and are directly in contact with freezing and thawing treated water.

FIG. 4 is an A-A section view of FIG. 3.

FIG. 5 is an installed position plan view of the ultrasonic vibrators in a case where the ultrasonic vibrators do not penetrate the tank bottom and underwater pressing lid of the freezing and thawing treatment tank and are externally adhered to the bottom and the lid, respectively.

FIG. 6 is a whole section view and partial front view of a freezing and thawing apparatus of the present invention comprising ultrasonic vibrators, and performing freezing and thawing in an underwater-rotation mesh basket.

FIG. 7 is a whole section view and partial front view of a freezing and thawing apparatus of the present invention comprising ultrasonic vibrators, and performing freezing and thawing in a state of an underwater submersion by a wire mesh chain conveyor in an underwater-rotation mesh basket.

FIG. 8 is an example of a vacuum packed container for a limp shape thing such as nigiri sushi, and is a plan view of a set vacuum package of a definite-piece number set for maintaining a shape of the nigiri sushi and the like and freezing them with maintaining their freshness.

FIG. 9 is an A-A section view of FIG. 8.

FIG. 10 is the A-A section view in a state of a vacuum package upper film and a vacuum package lower film being separated.

FIG. 11 is a section view of the vacuum package upper film and the vacuum package lower film before their circumferences are melted and adhered, wherein pieces of nigiri sushi are packed in the vacuum package upper film and the vacuum package lower film in a shape of a set vacuum package of the nigiri sushi.

FIG. 12 is a section view of the vacuum package upper film and the vacuum package lower film in a state of the air being eliminated after their circumferences are melted and adhered, wherein pieces of nigiri sushi are packed in the upper and lower films in a shape of the set vacuum package of the nigiri sushi.

FIG. 13 is a plan view of a thin thickness container with a transparent lid of a definite-piece set for eliminating oxygen by filling an inert gas in a vacuum packed container for a limp shape thing such as nigiri sushi and freezing the limp shape thing with maintaining its freshness.

FIG. 14 is an A-A section view of FIG. 13.

FIG. 15 is a section view of a thin thickness container with a transparent lid, where pieces of nigiri sushi are packed, before a circumference of the lid is melted and adhered,.

FIG. 16 is a section view of the thin thickness container with the transparent lid, where the pieces of the nigiri sushi are packed, after the circumference of the lid is melted and adhered.

FIG. 17 is a plan view of a thin thickness container with a transparent lid of a definite-piece set for eliminating oxygen by filling an inert gas in a vacuum packed container for a limp shape thing such as a sushi neta cooked and sashimi; and for performing freezing the limp shape thing with maintaining its freshness.

FIG. 18 is an A-A section view of FIG. 17.

FIG. 19 is a section view of the thin thickness container with the transparent lid, where a sushi neta cooked, sashimi, and the like are packed, before a circumferences of the lid is melted and adhered,.

FIG. 20 is a section view of the thin thickness container with the transparent lid, where a sushi neta cooked, sashimi, and the like are packed and an inert gas is filled, after the circumference of the lid is melted and adhered.

### BEST MODE(S) FOR CARRYING OUT THE INVENTION

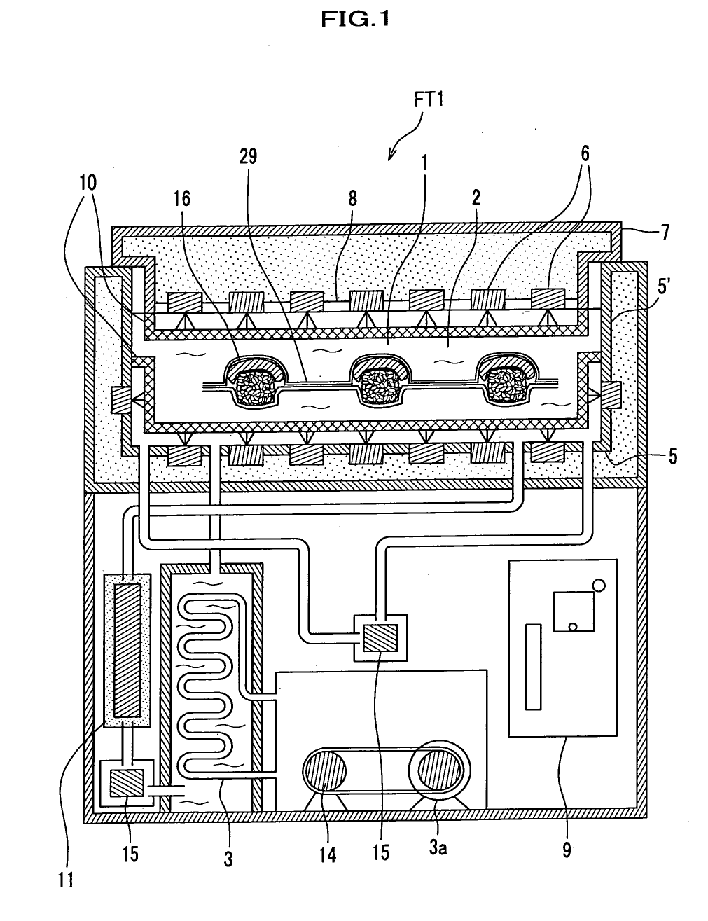

In a freezing and thawing apparatus FT1 of FIG. 1A, a material of a freezing and thawing treatment tank 1 is preferably a stainless steel sheet of SUS (Special Used Stainless) 304 or SUS 316 for the apparatus FT1 of home-use small one to business-use large one because a thawed stuff is a food. When the freezing and thawing apparatus FT1 is made of resin, it is assumed to be a resin product complying a law and regulation and having no health hazard.

The freezing and thawing treatment tank 1 of the home use is any of a freezer built-in type, a sink built-in type, and desk-top portable small type; the tank 1 of the business use varies in shape and size according to any of an installed place, a thawing treatment amount, a physical property, an operation control system, and the like. Although a frozen stuff is thawed with freezing and thawing treated water 2 of a room temperature in some case, the freezing and thawing treatment tank 1 is assumed to be a heat insulation structure as far as it is mainly used at not more than an ice temperature.

A heat insulation purpose of the freezing and thawing treatment tank 1 is to cool and maintain the freezing and thawing treated water 2 at an ice temperature of around −18 Celsius degrees by a treated water cooler 3, other than to immediately eat a frozen stuff after it is thawed. Thus it is possible to prevent freshness of the thawed stuff from being degraded.

With respect to the heat insulation structure of the freezing and thawing treatment tank 1, various heat insulation sheets are attached to an outer wall of the tank 1, and an outside portion thereon is beautified by any of a cosmetic steel sheet and a resin sheet.

If a bottom 5 and side walls 5′ of the freezing and thawing treatment tank 1 are made a double-layer tank, and gap air thereof is suctioned by a vacuum pump, it is not necessary to dispense a cosmetic steel sheet all over outer faces of the double-layer tank, and the outer wall of the tank is also available as it is. Thus an efficiency of the heat insulation is enhanced.

With respect to a water temperature of the freezing and thawing treated water 2 filled in the freezing and thawing treatment tank 1, even a room temperature is available if a frozen stuff is thawed and immediately eaten. Even then, it is preferable in thawing the frozen stuff to throw crushed ice in the freezing and thawing treated water 2 and to make it crushed ice thrown-in water 4. This is to prevent the freshness of the thawed stuff from being degraded.

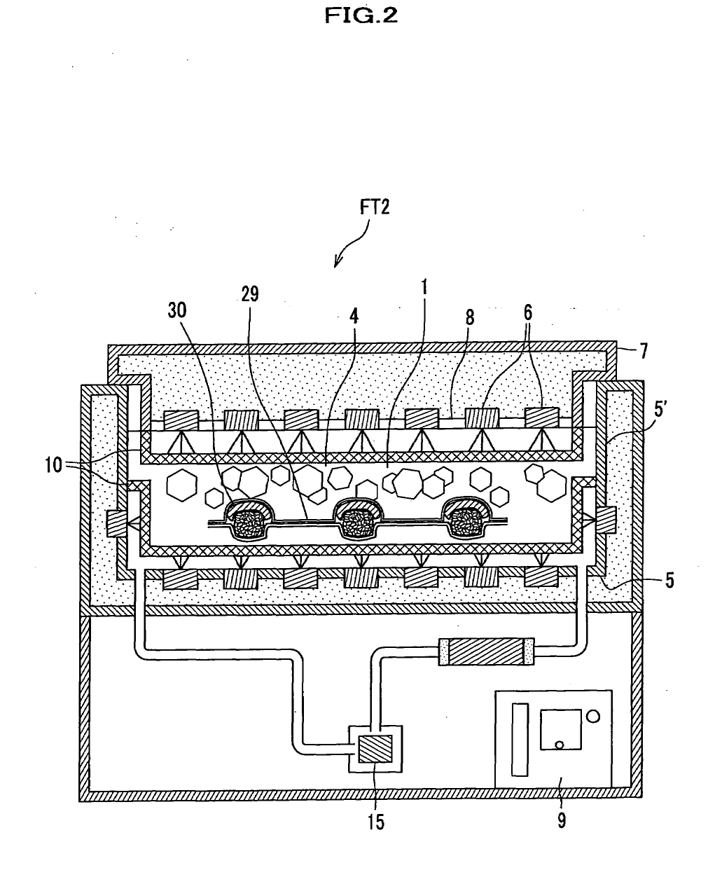

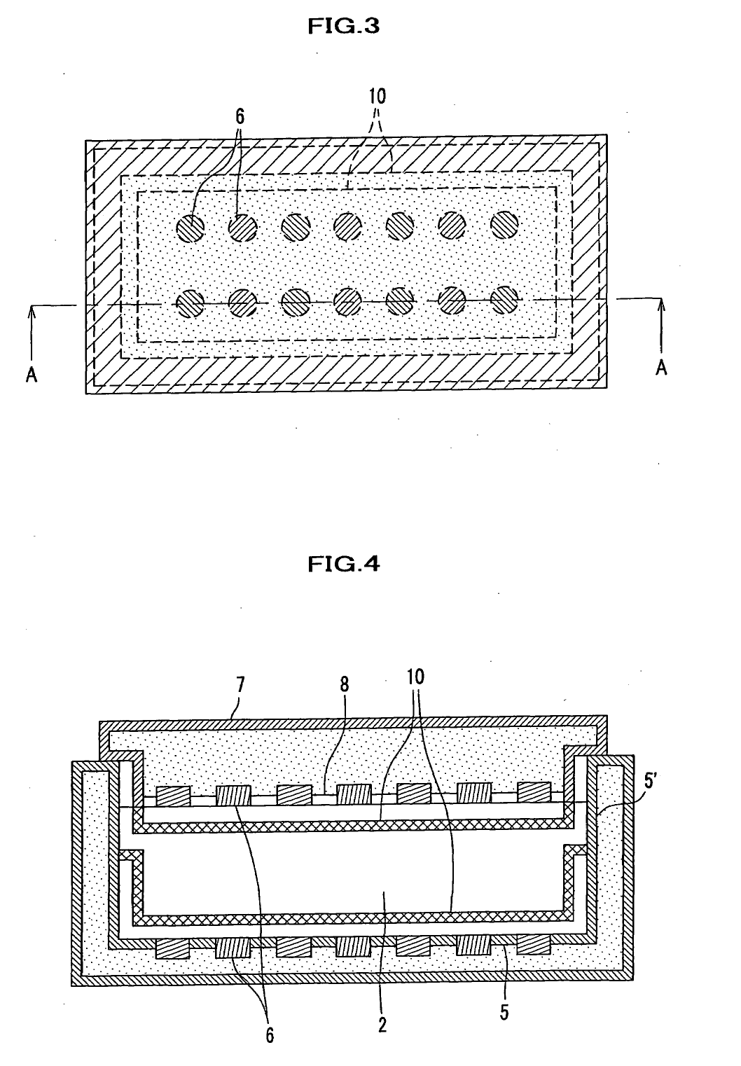

Because the home-use small apparatus FT1 is not continuously used and a frozen stuff is thawed by the apparatus FT1 and cooked immediately in most cases, the water temperature of the freezing and thawing treated water 2 suffices to be any of a room temperature and an ice temperature of the crushed ice thrown-in water 4. Therefore, the treated water cooler 3 is not installed as shown in FIG. 2 (freezing and thawing apparatus FT2).

The water temperature of the freezing and thawing treated water 2 filled in the freezing and thawing treatment tank 1 of the freezing and thawing apparatus FT1 is assumed to be available at any of: a room temperature of room temperature clear water; the ice temperature of the crushed ice thrown-in water 4; a temperature of around −8 Celsius degrees in a case of a frozen stuff being thawed by the treated water cooler 3; and as low as a temperature of −40 Celsius degrees in a case of freezing processing of a food.

When the water temperature of the freezing and thawing treated water 2 is maintained at a temperature of not more than zero Celsius degree other than a room temperature, ethanol is added to the water 2 at a ratio to a treated water volume for preventing the water 2 from being frozen and also a germicidal action is considered. Ethanol is added to the freezing and thawing treated water 2 as much as 15 percent in a thawing treatment of a frozen stuff at a treated water temperature of −8 Celsius degrees; and in the case of the freezing processing, as much as 40 percent at a treated water temperature of −30 Celsius degrees, as much as 50 percent at a treated water temperature of −40 Celsius degrees, and as much as 59.99 percent at a treated water temperature of −50 Celsius degrees. As the freezing and thawing treated water 2, there exists ethanol added water and clear water with no alcohol addition.

To a tank bottom 5 of the freezing and thawing treatment tank 1 are attached ultrasonic vibrators 6 for oscillating ultrasound toward a tank water surface, and a number of the vibrators 6 depends on an area of the bottom 5 and an output magnitude of the vibrators 6.

Furthermore, also to an underwater pressing lid 8 of a freezing and thawing treatment tank lid 7 are attached at least one of the ultrasonic vibrators 6 for oscillating ultrasound toward the tank bottom 5. This is intended to make an underwater wave from the ultrasonic vibrators 6 averagely strike, for example, frozen nigiri sushi and the like from up, down, and sides thereof in thawing them; to make partial nonuniformity in thawing them not to exist; and to shorten their treatment time. Thus it becomes possible to maintain the freshness of the nigiri sushi and the like. The ultrasonic vibrator 6 is attached also to the underwater pressing lid 8 and the tank side walls 5′ by a number depending on the shortened treatment time.

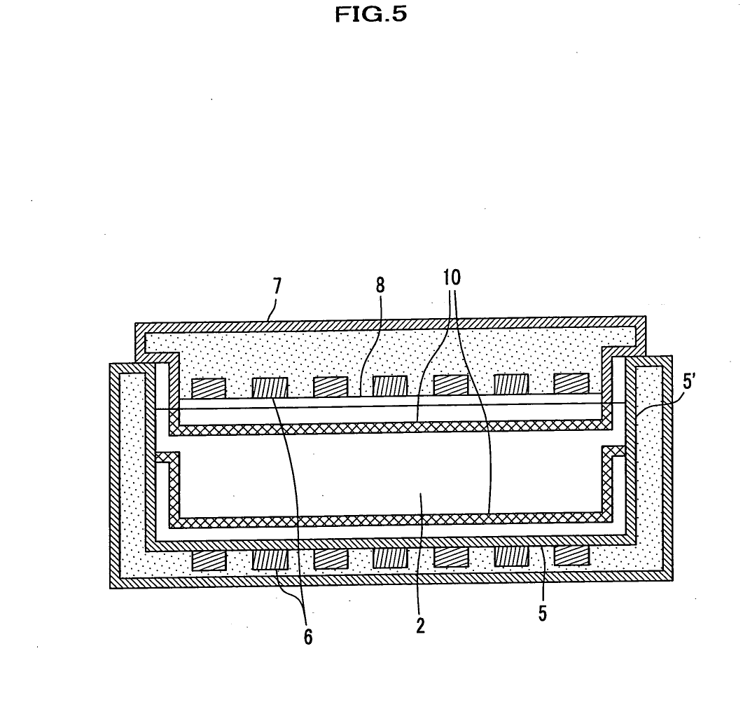

In a case of FIG. 5 an underwater wave is generated by vibrating the tank bottom 5 and the underwater pressing lid 8 themselves made of metal.

It is also possible to not attach the ultrasonic vibrator 6 with penetrating tank walls 5, 5′ of the freezing and thawing treatment tank 1, to throw in the water a box where at least one ultrasonic vibrator 6 is attached separately, and to make the box the ultrasonic vibrator 6.

With respect to an oscillation frequency from the ultrasonic vibrators 6 attached to the tank bottom 5 and the underwater pressing lid 8, there exist a case of the oscillation frequency being switched between a frequency of a same wavelength and that of a different wavelength; and a case of one kind of a fixed wavelength. Also with respect to a wavelength from the ultrasonic vibrators 6 attached only to the tank bottom 5, there exist a case of being switched between a plurality of wavelengths and a case of a fixed frequency of one kind of a wavelength.

The purpose of switching an oscillation frequency is to make strong ultrasound strike sushi rice of a lower portion and weak ultrasound sushi neta of an upper portion because there exists a big time difference in thawing the sushi rice and the sushi neta as in vacuum packed frozen nigiri sushi. Furthermore, when there exist a large amount of frozen stuffs, the frequency is changed by increasing and decreasing an output of the ultrasonic vibrator 6 and by simultaneously selecting a heat conversion ratio of a wave energy of the frequency. The ultrasonic vibrators 6 described above are controlled by an ultrasound oscillation electric circuit 9.

If an underwater wave from the ultrasonic vibrators 6 attached to the tank bottom 5 and the underwater pressing lid 8 is not diffusive but direct advancing, an underwater wave diffusion net 10 having holes of around 3 mm is attached at an underwater position away from each ultrasonic vibrator 6 by around 20 mm.

An underwater ultraviolet germicidal lamp 11 is attached in order to sterilize the freezing and thawing treated water 2. Thus it becomes possible to bring about a high germicidal effect.

In the freezing and thawing apparatus FT1 shown in FIG. 6, it is also possible to attach an underwater rotation mesh basket 12 rotated by a drive device 12b in the freezing and thawing treated water 2 as needed so that an underwater wave from the ultrasonic vibrators 6 uniformly strike a frozen stuff to be thawed and so that there does not exist nonuniformity in thawing the stuff. The underwater rotation mesh basket 12 is effective for thawing a separated stuff in a single stuff vacuum package and the like.

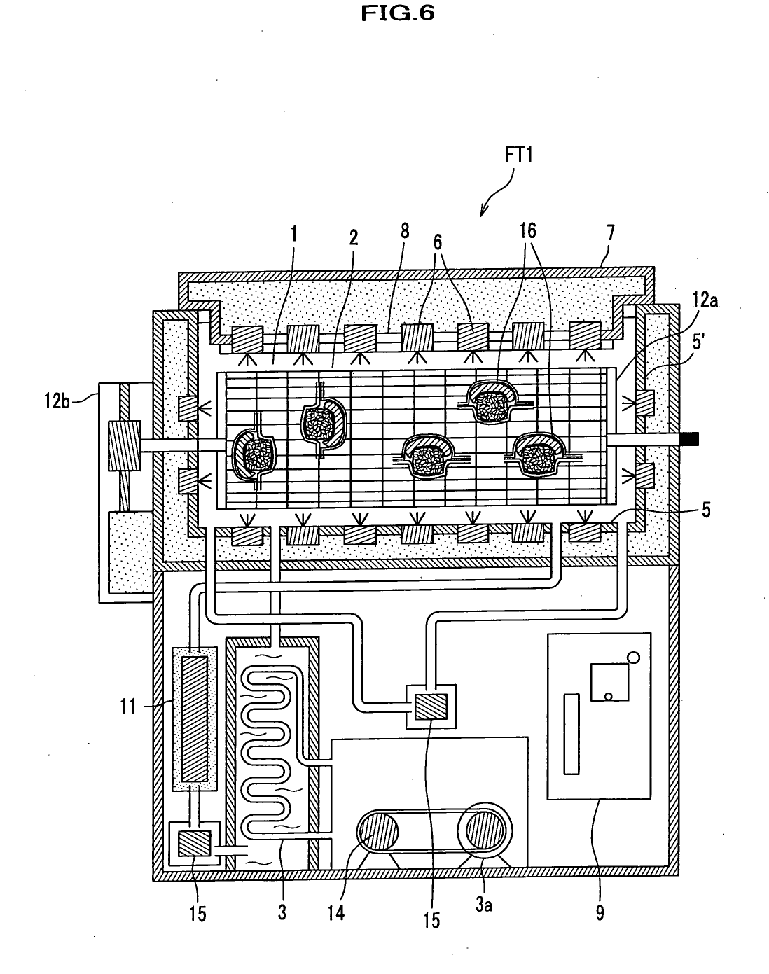

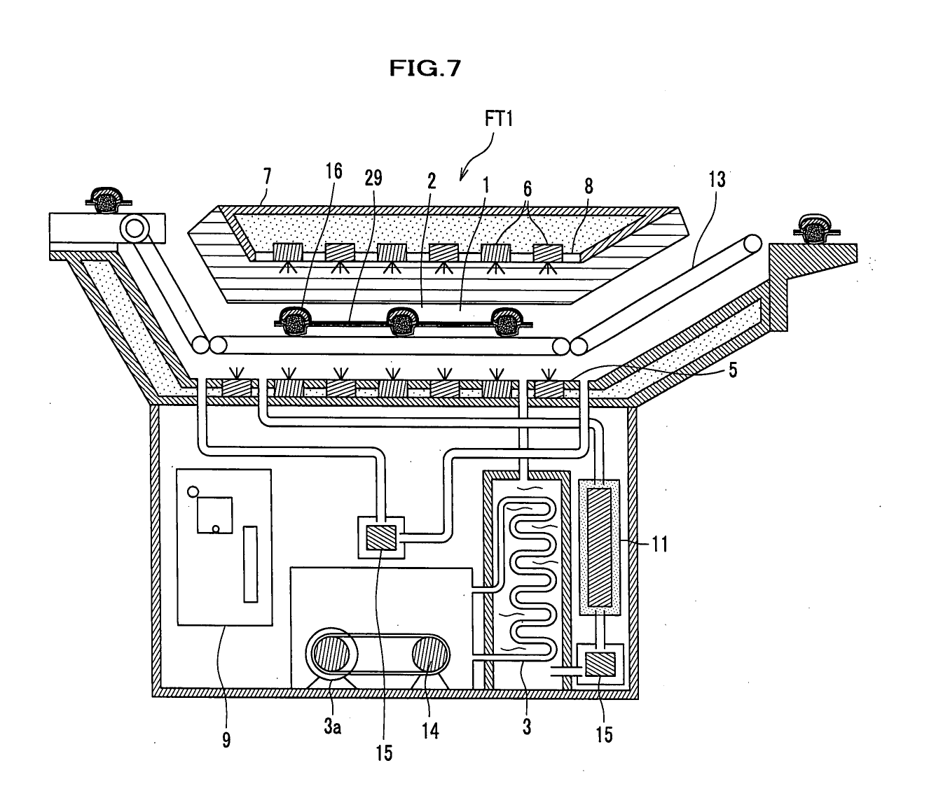

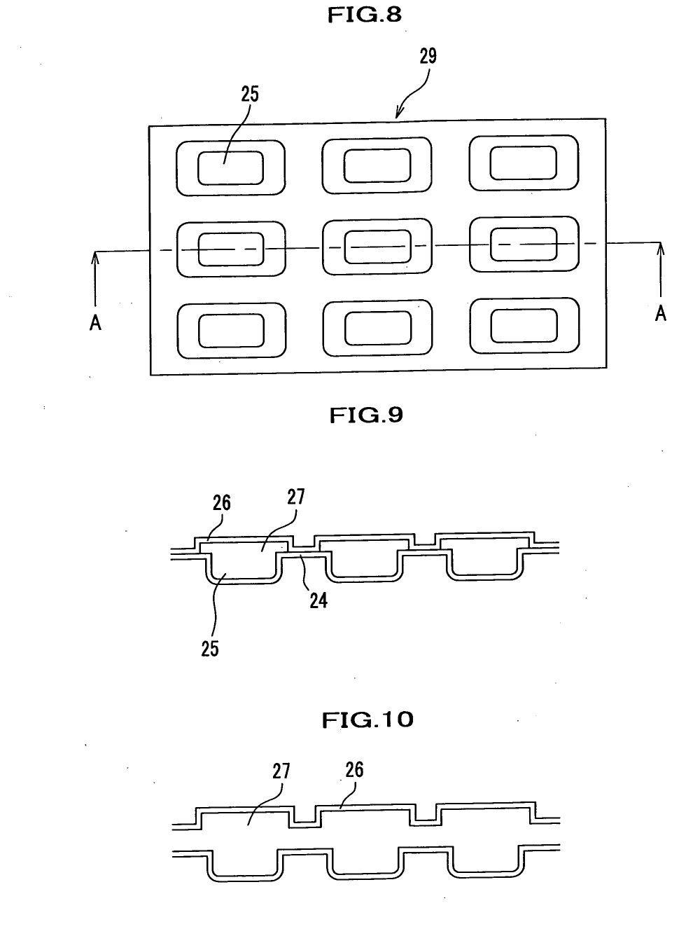

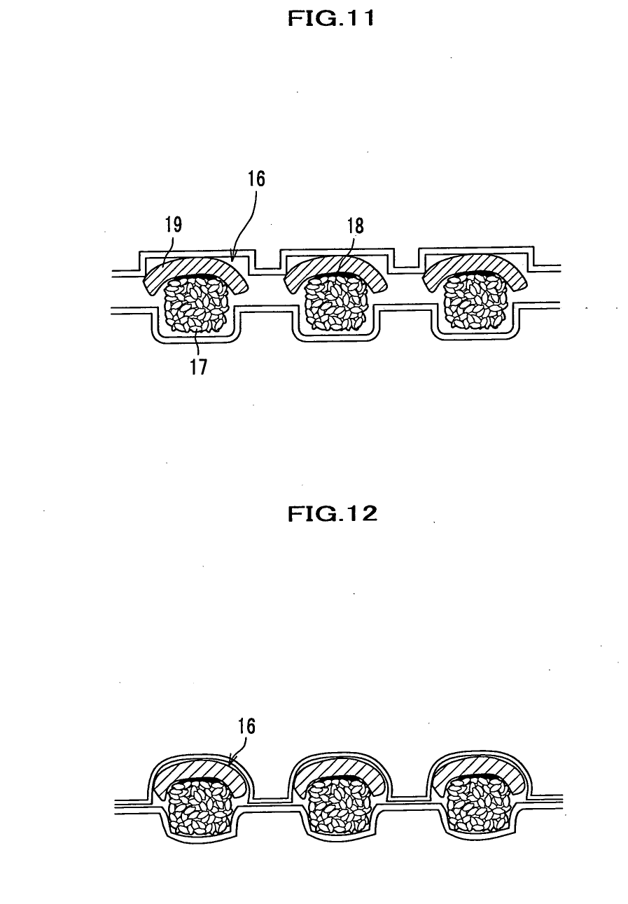

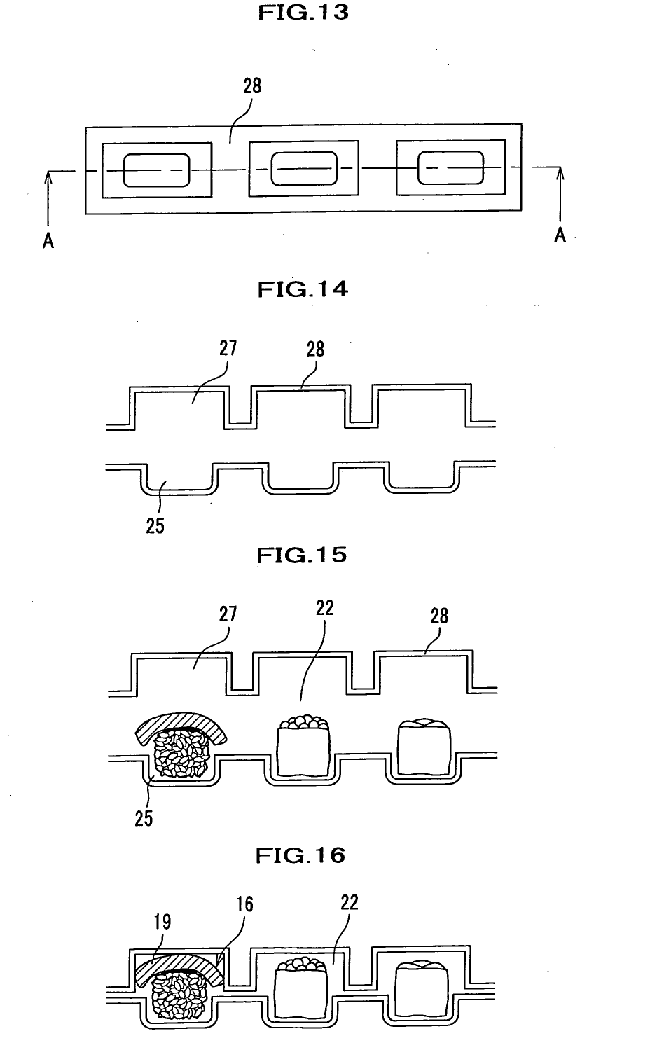

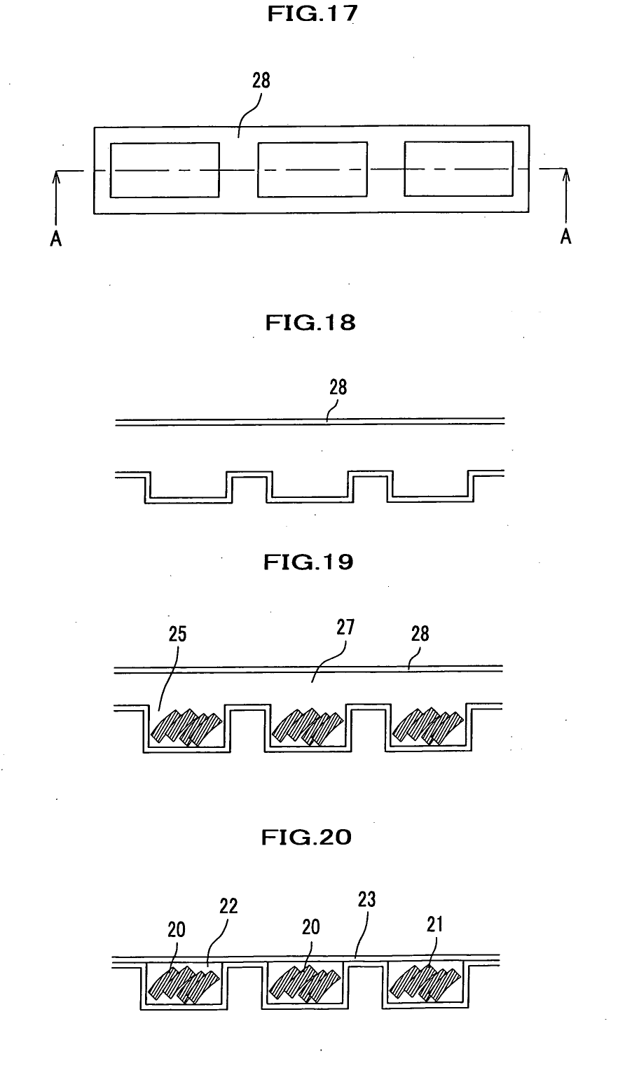

In a business area where thawing a large amount of frozen stuffs is temporary required, with respect to the freezing and thawing apparatus FT1 shown in FIG. 7, it becomes possible to pass the stuffs through the freezing and thawing treated water 2 in the freezing and thawing treatment tank 1 in a definite time by an endless-rotation metal mesh conveyor 13 and to thaw the stuffs. In this case, because the metal mesh conveyor 13 plays a role of the underwater wave diffusion net 10, it is not necessary to attach the net 10. Depending on a needed thawing time, an underwater passing time is controlled.

The freezing and thawing apparatus FT1 operates an existing power using generator 14 by using power derived from a rotation of a cooler drive motor 3a of the treated water cooler 3 attached to the apparatus FT1. This enables electricity saving.

When a volume of the freezing and thawing treatment tank 1 is large in a case of a large apparatus, an in-tank treated water circulation pump 15 is provided and an in-tank water flow agitation is performed.

According to the present invention, frozen nigiri sushi 16 to be thawed is a unification of: commonly called sushi shari 17 of nigiri sushi rice; wasabi 18 put on the sushi shari 17; and commonly called sushi neta 19 of sashimi 20 and a cooked foodstuff 21.

The nigiri sushi 16, and each of the sushi shari 17, the wasabi 18, the sushi neta 19, and the like are individually vacuum-packed, or else packed in a inert-gas-filled container 23, where an inert gas such as a nitrogen gas and other inert gas 22 is injected and sealed; and are shielded from outside air.

In the case of the vacuum package, according to the air degass method of a conventional mere limp flat vacuum film, shapes of the sushi shari 17 and the sushi neta 19 are broken similarly to spherical shapes by an outside pressure due to an air suction and their value as a goods is lost. Therefore, a sushi shari embedded depression 25 of a size, by which the sushi shari 17 is just embedded in a vacuum package lower film 24, is molded at a specified position. When the sushi neta 19 is large so as to exceed and cover a length of the sushi shari 17, the lower face portion of the vacuum package lower film 24 is made to have an affordable flat area of the portion, the sushi neta 19 is put on the sushi shari 17, and the protruded portion is horizontally extended and put. Thus it is possible to maintain a shape of the nigiri sushi 16.

A sushi neta cover space 27 of a size by which the sushi neta 19 is put in a vacuum package upper film 26 is molded. Then the whole of the sushi neta 19 horizontally put on the sushi shari 17 is put in the sushi neta cover space 27.

The sushi shari 17 of the nigiri sushi 16 is packed in the sushi shari embedded depression 25 of the vacuum package lower film 24, the sushi neta 19 is covered with the vacuum package upper film 26 having the sushi neta cover space 27 that is horizontal to the upper portion of the sushi shari 17 and is associated with a thickness and area of the sushi neta 19. Then circumferences of the upper and lower films 24, 26 are sealed, and simultaneously, the package is vacuum degassed. Although the vacuum package lower film 24 and the vacuum package upper film 26 are flexible, a shape of the nigiri sushi 16 itself is maintained, and a freshness degradation due to a low temperature and dryness does not occur which is a defect of a conventional method.

Furthermore, in some case, this package is not completely vacuum degassed, is sealed with slight air remaining, enters into freezing processing, and is completely vacuum degassed in a freezing-proceeding process or at a freezing processing completion time. In this case, the sushi shari 17 and the sushi neta 19 are frozen and solidified in a state of rice grain protrusions existing in the sushi shari 17 and an acute angle of a cut edge in sashimi cooking existing in the sushi neta 19, and in this state their vacuum package becomes possible.

Furthermore, there exist a sea urchin, a salmon roe, other fish roe, and the like in original sushi neta 19 of the nigiri sushi 16, and in a normal vacuum flat film package a shape of the sushi neta 19 is broken in the degas process. Therefore, the sea urchin, the salmon roe, the other fish roe, and the like are packed with a soy sauce and a ginger in a thin thickness container 28 with a transparent lid; a nitrogen gas and other inert gasses 22 are injected and sealed; and thus the container 28 is not vacuum degassed but is made in a state of an oxygen depletion. This purpose is to prevent an oxidation from proceeding in the freezing-processing process and to maintain the freshness. Then the circumference of the thin thickness container 28 with the transparent lid is sealed. As a matter of course, because the nitrogen gas and the like are a heat insulation material as far as they are a gas, the space inside the thin thickness container 28 with the transparent lid is preferably a shrank shape as small as possible after the nigiri sushi 16 and the like are packed.

With respect to the freezing processing of the sea urchin, the salmon roe, the other fish roe, and the like, a best condition of the processing is that: the processing is performed at a temperature as low as possible, in a short time of around five minutes as short as possible, in a state of the shape of the sushi neta 19 being maintained as it is hand-rolled, in a state of a space in the sushi neta 19 being eliminated as little as possible, and in a state of no oxygen existing; and in particular, the sushi neta 19 is rapidly frozen in the processing.

Another shape-maintaining freezing processing method is a method of: instantaneously or in a definite time freezing and fixing the shapes of the nigiri sushi 16, and each of the sushi shari 17, the wasabi 18, the sushi neta 19, and the like by discharging any of a liquefied nitrogen gas and carbon dioxide gas of a temperature of around −50 Celsius degrees; maintaining the shapes when they are vacuum degassed; and performing freezing processing. Even in this case there is a method of packing the nigiri sushi 16, and each of the sushi shari 17, the wasabi 18, the sushi neta 19, and the like by a wrap film of plastic; freezing and fixing their shapes; taking them out from the wrap film; vacuum packing them as a set vacuum package 29; and refreezing them in a low temperature air freezer.

When the nigiri sushi 16, and each of the sushi shari 17, the wasabi 18, the sushi neta 19, and the like are instantaneously and rapidly frozen, fixed, and maintained in their shapes by any of a liquefied nitrogen gas and a carbon dioxide gas, freezing the nigiri sushi 16 and the like is completed almost to their cores in some case. Also in vacuum degassed-package processing of a vacuum package and the like of a next process, it is possible to maintain the shapes of the nigiri sushi 16 and the like in their original shapes.

According to this method, the sushi neta 19, which is limp and different in size, of each kind of the nigiri sushi 16 is vacuum-packed and frozen processed in a state of an original shape of the neta 19 as it is before the freezing processing in the shape of the neta 19 put on the sushi shari 17, without the shape being broken and a moisture of the neta 19 being sucked and discharged.

With respect to the nigiri sushi 16, and each of the sushi shari 17, the wasabi 18, the sushi neta 19, and the like frozen and fixed in their shape, a definite size of the set vacuum package 29 is used for them, corresponding to a definite number of pieces in any of their same kind and various kinds mixed. Thus vacuum packed frozen nigiri sushi 30, vacuum packed frozen sushi shari, vacuum packed frozen sushi neta, vacuum packed frozen sashimi, a vacuum packed frozen cooked foodstuff, and the like are individually frozen and stored.

The set vacuum package 29 is applied to the vacuum packed frozen nigiri sushi 30 in which frozen sushi shari of a definite shape is a protrusion shape and frozen sushi neta is any of a flat shape and a protrusion shape by a thickness of the neta.

An array of the set vacuum package 29 is plane-positionally made constant at an interval of longitudinal and lateral arrays, and thus an efficiency in rapidly thawing the nigiri sushi 30 is accelerated in a last process with maintaining its freshness.

Experiments were performed in two kinds of apparatuses: in one apparatus the ultrasonic vibrators 6 are installed at both of the tank bottom 5 and the underwater pressing lid 8; and in another apparatus the ultrasonic vibrators 6 are installed only at the tank bottom 5.

In a freezing processing experiment of the nigiri sushi 16, the set vacuum package 29 was used; a rapid freezing processing was performed for around five minutes in the freezing and thawing treated water 2 of −30 Celsius degrees; and an oscillation frequency from the ultrasonic vibrators 6 was made a wavelength of 40 KHz, ultrasound was oscillated for first two minutes, and stopped. Thus the freezing processing was as a whole simultaneously completed inside and outside the nigiri sushi 16 with its freshness being maintained and a moisture-containing fine-crystal ice-freezing the sushi 16, without the texture of the sushi neta 19 being broken.

In thawing the vacuum packed frozen nigiri sushi 30, the oscillation frequency is changed, depending on its requested frozen time, in order to thaw the sushi 30 at its core temperature of −three Celsius degrees in the freezing and thawing treated water 2 of around −eight Celsius degrees. In the experiments ultrasound of a frequency of 170 KHz was oscillated in the freezing and thawing treated water 2, and the thawing processing was performed in around fifteen minutes. As a result thereof, the freshness and color of the nigiri sushi 30 were good; its taste was similar to that of nigiri sushi just hand-rolled.

The ultrasonic vibrators 6 only at the tank bottom 5 are enough to freeze and thaw a thin material such as the sushi neta 19. When a thawing time was set, oscillation frequencies of 40 KHz, 80 KHz, and 120 KHz were used. Although there existed a slight difference of a few minutes, a good result was obtained.

Because there exists a thawing time difference between thawing the sushi shari 17 to its core and the thin sushi neta 19 in the thawing processing of the vacuum packed frozen nigiri sushi 30, the sushi shari 17 of the sushi 30 is placed toward the tank bottom 5 of the freezing and thawing treatment tank 1 and the thawing processing is performed when the ultrasonic vibrators 6 are attached only to the tank bottom 5. When the ultrasonic vibrators 6 are attached to both of the tank bottom 5 and the underwater pressing lid 8 and moreover both oscillation frequencies are different, the sushi shari 17 is placed toward a higher frequency side of the both, and the thawing processing is performed. Thus it is possible for the sushi neta 19 to avoid excessive thawing by receiving ultrasound not less than needed. Because the freezing and thawing treated water 2 is not more than an ice temperature and the thawing time is 10 to 15 minutes and short, there exists no freshness degradation and taste degradation of the sushi neta 19 at all.

In the present invention in-air freezing and in-air thawing are avoided and the underwater freezing and the underwater thawing are applied. This is because a thermal heat transfer coefficient in water is extremely large, different from that in the air. Thus according to the invention, the ice freezing crystal of the nigiri sushi 16 is miniaturized due to the low temperature rapid instantaneous freezing thereof for around five minutes and the texture of the sushi neta 19 is not broken. Furthermore, the freshness and quality of the frozen sushi neta 19 vacuum packed are not degraded neither due to the rapid instantaneous thawing of the nigiri sushi 30 around 15 minutes in the water of −eight Celsius degrees.

By oscillating ultrasound toward fresh foodstuffs and the like in the freezing and thawing treated water 2 of any of a room temperature and an ice temperature from the ultrasonic vibrators 6 by the ultrasonic oscillation electric circuit 9, pesticides, other drugs, fungi, and the like of the foodstuffs and the like are removed, which are not seen by naked eyes and adhered to them. Thus it also becomes possible to make the freezing and thawing apparatuses FT1 and FT2 to be used as an underwater ultrasound washer of a fresh foodstuff, a kitchen utensil, a tableware, and the like before freezing and cooking the foodstuff.

Goo unique to a fish skin tends to become a propagation source of various fungi if any; particularly in fish, if a decomposition enzyme of skin goo is added to the freezing and thawing treated water 2 and the fish is washed by underwater ultrasound, it has a large effect in maintaining the freshness of the fish.

In any of meats, if a food protease enzyme for softening a meat texture is added to the freezing and thawing treated water 2 before the meat is frozen or thawed, and then it is washed, it becomes soft after being cooked.

If blended rice of sushi shari before being cooked is impregnated with a glucoamylase enzyme in the freezing and thawing treated water 2 by underwater ultrasound and is vacuum-packed and frozen, a moisture attainment degree to the rice core is increased when the sushi shari is heated; thus although the sushi shari is frozen and contains water, it is delicious above all.

The present invention has been described with respect to freezing and thawing nigiri sushi, which is a collaboration food with wasabi and is unique to Japan. Thus it is possible to describe the best mode for carrying out freezing and thawing any of other foods and foodstuffs.

What is claimed is:

1. A freezing and thawing apparatus having a freezing and thawing treatment tank for filling freezing and thawing treated water, a plurality of ultrasonic vibrators for oscillating ultrasound different in frequency in the freezing and thawing treatment tank, and a treated water cooler for cooling the freezing and thawing treated water, the apparatus further comprising:
an ultrasonic vibrator controller configured to control the ultrasonic vibrators.

2. The freezing and thawing apparatus according to claim 1, wherein the freezing and thawing treated water is ethanol added water.

3. The freezing and thawing apparatus according to claim 1, wherein at least one of the ultrasonic vibrators is attached to a tank bottom of the freezing and thawing treatment tank.

4. The freezing and thawing apparatus according to claim 1 further comprising a freezing and thawing treatment tank lid and at least one of the ultrasonic vibrators are attached to an underwater pressing lid of the freezing and thawing treatment tank lid.

5. The freezing and thawing apparatus according to claim 1, wherein the ultrasonic vibrator controller is an ultrasound oscillating electric circuit.

6. The freezing and thawing apparatus according to claim 1 further comprising an underwater wave diffusion net in the freezing and thawing treatment tank.

7. The freezing and thawing apparatus according to claim 1 further comprising a wire mesh chain conveyor.

8. The freezing and thawing apparatus according to claim 1 further comprising an underwater-rotation mesh basket in the freezing and thawing treatment tank.

9. The freezing and thawing apparatus according to claim 1 further comprising an underwater ultraviolet germicidal lamp.

10. The freezing and thawing apparatus according to claim 1 further comprising an existing power using generator.

11. The freezing and thawing apparatus according to claim 1 further comprising an in-tank treated water circulation pump.

12. The freezing and thawing apparatus according to claim 1, wherein a decomposing enzyme is added to the freezing and thawing treated water.

13. The freezing and thawing apparatus according to claim 1, wherein a food protease enzyme is added to the freezing and thawing treated water.

14. The freezing and thawing apparatus according to claim 1, wherein a glucoamylase enzyme is added to the freezing and thawing treated water.

15. A thawing method of a frozen stuff in the freezing and thawing apparatus including a freezing and thawing treatment tank having at least one of the ultrasonic vibrators attached to a tank bottom of the freezing and thawing treatment tank, a plurality of ultrasonic vibrators at least one of the ultrasonic vibrators are attached to an underwater pressing lid of the freezing and thawing treatment tank lid, a treated water cooler, and an ultrasonic vibrator controller, the method having a throw-in process of throwing the frozen stuff in the freezing and thawing treatment tank where the freezing and thawing treated water is filled, and an oscillation process of oscillating ultrasound different in frequency from the ultrasonic vibrators in the freezing and thawing treatment tank, the method further comprising:
a control process of controlling the ultrasonic vibrators.

16. The thawing method according to claim 15, wherein the oscillation process is a process of oscillating ultrasound from the ultrasonic vibrator attached to the tank bottom of the freezing and thawing treatment tank.

17. The thawing method according to claim 15, wherein the oscillation process is a process of oscillating ultrasound from some ultrasonic vibrators attached to the underwater pressing lid of the freezing and thawing treatment tank lid.

18. The thawing method according to claim 15 further comprising a process of making a thrown-in frozen stuff a set vacuum package.

19. The thawing method according to claim 15 further comprising a process of making a thrown-in frozen stuff a thin-thickness container with a transparent lid.

20. The thawing method according to claim 18, wherein the frozen stuff is frozen nigiri (hand-rolled) sushi including sushi shari (rice) and sushi neta (material), and wherein the oscillation process is a process of the ultrasonic vibrators oscillating ultrasound different in frequency toward the sushi shari and the sushi neta.

21. The thawing method according to claim 19, wherein the frozen stuff is frozen nigiri sushi including sushi shari and sushi neta, and wherein the oscillation process is a process of the ultrasonic vibrators oscillating ultrasound different in frequency toward the sushi shari and the sushi neta.
